(19) United States
(12) Patent Application Publication
(10) Pub. No.: US 2002/0156832 A1
(43) Pub. Date: Oct. 24, 2002

(54) Method and apparatus for dynamic bookmarks with attributes

(75) Inventors: Sastry S. Duri, Yorktown Heights, NY (US); James Edward Christensen, Cortlandt Manor, NY (US); Alan George Cole, Katonah, NY (US); Paul Andrew Moskowitz, Yorktown Heights, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/837,477

(22) Filed: Apr. 18, 2001

(51) Int. Cl. G06F 7/00

(52) U.S. Cl. 709/203

(57) ABSTRACT

A method, apparatus, and computer implemented instructions for managing bookmarks. In response to detecting a service domain with a dynamic bookmark service, a client device sends a request containing criteria identifying a dynamic bookmark to the service domain. In these examples, the dynamic bookmark contains attributes or criteria that may be used to bind or locate regular bookmarks having similar attributes or criteria. The request is received by a server, which queries a data structure using the criteria for a bookmark, corresponding to or matching the criteria, to generate a result. This result is returned in a response to the client. The client processes any bookmarks received in the response, wherein any bookmarks returned in the request are bookmarks matching the dynamic bookmark.

### BACKGROUND OF THE INVENTION

1. Technical Field

The present invention relates generally to an improved data processing system and in particular to a method and apparatus for managing data within a data processing system. Still more particularly, the present invention provides a method and apparatus for managing bookmarks in a data processing system.

2. Description of Related Art

The Internet, also referred to as an “internetwork”, is a set of computer networks, possibly dissimilar, joined together by means of gateways that handle data transfer and the conversion of messages from protocols of the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a UTRL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

Two widely recognized modes are present in which a client receives information from a server: pull mode and push mode. In the pull mode, the client receives information in response to a request it has sent to the server. In the push mode the server sends information to the client without the client first requesting it. Internet browsing is an example of pull mode. E-mail sent regarding upcoming conferences, product promotions are examples of push mode. These modes for receiving information are satisfactory for many clients, which are desktop computers or personal computers. When the client is a small handheld mobile unit, such as, a cell phone or PDA, both of these modes are currently unsatisfactory. The pull mode makes too many demands for user input on these small devices, and the push mode overloads not only the storage and display capabilities of the devices, but the end user's tolerance for “electronic junk mail/calls” as well.

Therefore, it would be advantageous to have an improved method and apparatus for obtaining information in which less demand is made on a user at a client.

### SUMMARY OF THE INVENTION

The present invention provides a method, apparatus, and computer implemented instructions for managing bookmarks. In response to detecting a service domain with a dynamic bookmark service, a client device sends a request containing criteria identifying a dynamic bookmark to the service domain. In these examples, the dynamic bookmark contains attributes or criteria that may be used to bind or locate regular bookmarks having similar attributes or criteria. The request is received by a server, which queries a data structure using the criteria for a bookmark, corresponding to or matching the criteria, to generate a result. This result is returned in a response to the client. The client processes any bookmarks received in the response, wherein any bookmarks returned in the request are bookmarks matching the dynamic bookmark.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram of a personal digital assistant (PDA) shown in accordance with a preferred embodiment of the present invention;

FIG. 5 is a diagram illustrating components used to implement dynamic bookmarks in accordance with a preferred embodiment of the present invention;

FIG. 6 is a diagram illustrating sample entries of bookmark and attribute associations in accordance with a preferred embodiment of the present invention;

FIG. 7 is a diagram of dynamic bookmark entries in accordance with a preferred embodiment of the present invention;

FIG. 8 is a diagram illustrating a graphical user interface for creating a dynamic bookmark in accordance with a preferred embodiment of the present invention;

FIG. 9 is a flowchart of a process for automatically updating dynamic bookmarks in a client in accordance with a preferred embodiment of the present invention; and

FIG. 10 a flowchart of a process for selecting bookmarks for a dynamic bookmark is depicted in accordance with a preferred embodiment of the present invention.

### DETAILED DESCRIPTION OF THE PREFERRED EMBODIMENT

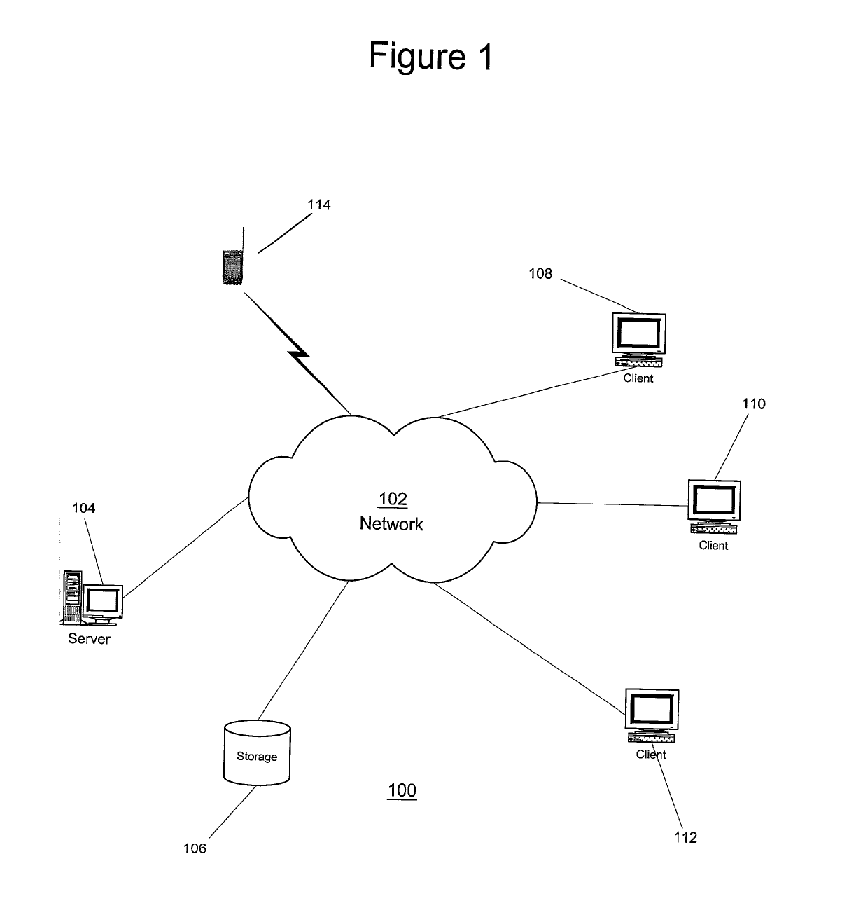

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, 112, and 114 also are connected to network 102. These clients 108, 110, and 112 may be, for example, personal computers or network computers. As illustrated, client 114 is a portable device taking the form of a personal digital assistant (PDA) and communicates with network 102 through a wireless communications link. Further, client 114 also maybe a cellular phone, an embedded device such as a computing system within an automobile, or a watch including wireless communication and processing functions. Wireless connection may be provided through various protocols for use with these types of devices.

In the depicted example, server 104 provides data, such as boot files, operating system images, and applications to clients 108-114. Clients 108, 110, 112, and 114 are clients to server 104. Network data processing system 100 may include additional servers, clients, and other devices not shown.

The present invention provides a method, apparatus, and computer implemented instructions for managing bookmarks with clients, especially with portable or small clients, such as client 114. This mechanism provides a system of dynamic bookmarks, which makes less demands on users of mobile devices. In these examples, a bookmark, also called a regular bookmark, in contrast to a dynamic bookmark, consists of a name (string) and a universal resource locator (URL). As used herein, a dynamic bookmark consists of a set of attributes or criteria that dynamically bind to a set of zero or more regular bookmarks that have been augmented with similar attributes or criteria. The dynamic bookmark is located or stored within client 114. The dynamic binding process is performed by a dynamic bookmark server, which may be implemented using server 104. Server 104 receives a request from client 114 in which the request includes the set of attributes or criteria. Server 104 matches the attributes of the dynamic bookmark with those of the augmented bookmarks contained in a bookmarks and attributes database, which may be located within a storage device at server 104 or a remote storage device, such as storage unit 106.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

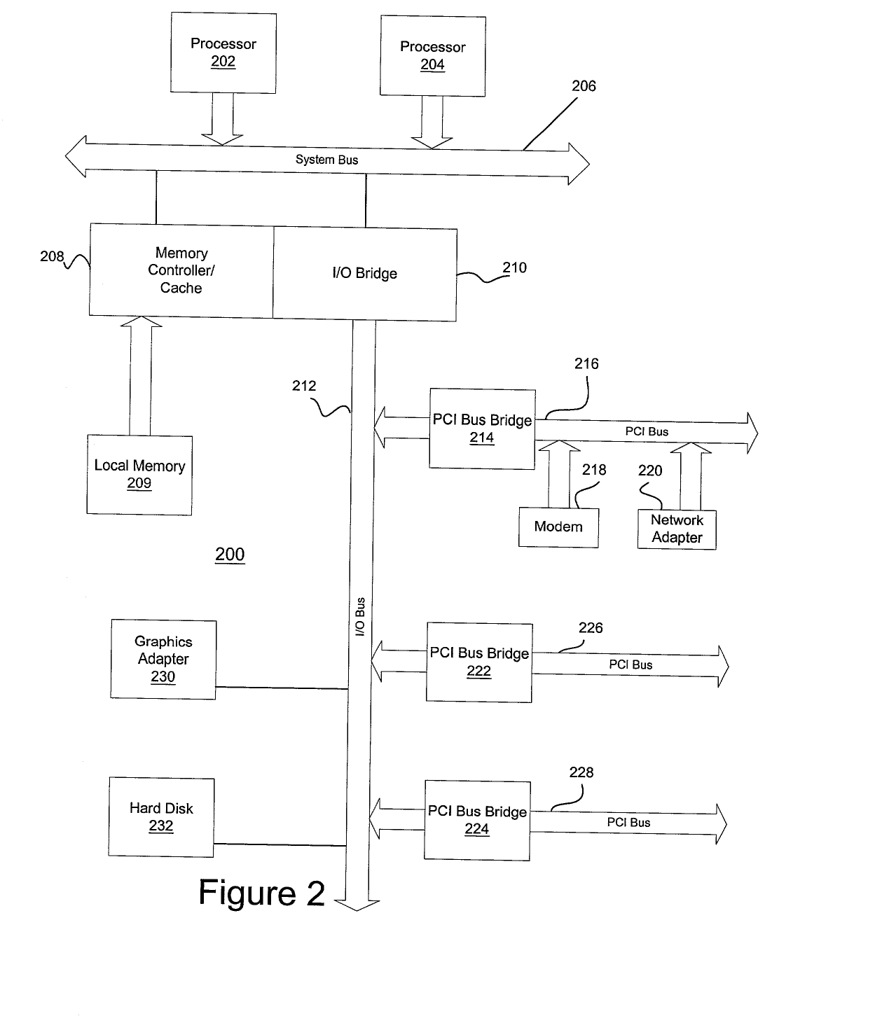

Referring to FIG. 2, a block diagram of a data processing system that may be implemented as a server, such as server 104 in FIG. 1, is depicted in accordance with a preferred embodiment of the present invention. In this example, data processing system 200 is implemented to act as a server to provide bookmarks to clients containing dynamic bookmarks.

Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

The processes of the present invention may be implemented in the form of computer instructions, which are executed by a processor, such as processor 202 or 204. These instructions may be stored within local memory 209 and hard disk 232. When data processing system 200 receives a request from a client, these instructions are executed to process the request. If the request contains attributes for a dynamic bookmark, these attributes are compared to or matched with attributes associated with bookmarks stored in a data structure, such as a database or a list. This data structure may be stored within hard disk 232 in these examples. A result is generated from the comparison. This result may contain from zero to some number of bookmarks depending on whether any bookmarks match or correspond to the attributes. These bookmarks are then returned to the client.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

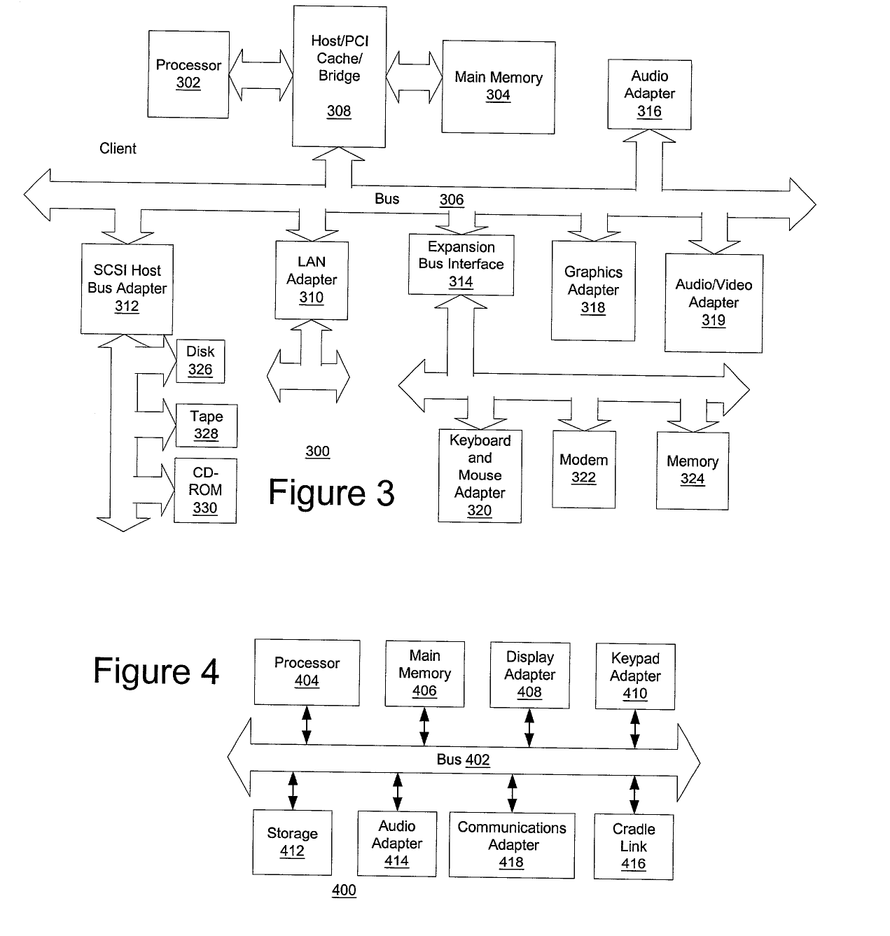

With reference now to FIG. 3, a block diagram illustrating a data processing system is depicted in which the present invention may be implemented. Data processing system 300 is an example of a client computer.

Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and maybe loaded into main memory 304 for execution by processor 302.

In this example, data processing system 300 may contain one or more dynamic bookmarks. A request may be sent to a server to obtain bookmarks based on the criteria or attributes for these dynamic bookmarks. It is to be understood that in this context, the words attributes and criteria may be used interchangeably. These dynamic bookmarks may be defined by a user selecting or entering the attributes or criteria for the dynamic bookmarks. A request may be sent to one or more servers containing these attributes or criteria when data processing system 300 establishes a connection with these servers. Responses are returned from these servers and any bookmarks returned in the response are added to a set of bookmarks present for use by the user. In this manner, less user input is required to obtain and create bookmarks.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 maybe a stand-alone system configured to be bootable without relying on some type of network communication interface, whether or not data processing system 300 comprises some type of network communication interface. As a further example, data processing system 300 may be a personal digital assistant (PDA) device, which is configured with ROM and/or flash ROM in order to provide nonvolatile memory for storing operating system files and/or user-generated data.

The depicted example in FIG. 3 and above-described examples are not meant to imply architectural limitations. For example, data processing system 300 also may be a notebook computer, kiosk, or a Web appliance.

Turning now to FIG. 4, a block diagram of a personal digital assistant (PDA) is shown in accordance with a preferred embodiment of the present invention. PDA 400 is an example of a PDA in which code or instructions implementing the processes of the present invention may be located. PDA 400 includes a bus 402 to which processor 404 and main memory 406 are connected. Display adapter 408, keypad adapter 410, storage 412, and audio adapter 414 also are connected to bus 402. Cradle link 416 provides a mechanism to connect PDA 400 to a cradle used in synchronizing data in PDA 400 with another data processing system. Communications adapter 418 provides a mechanism for PDA 400 to communicate with a server, such as server 104 in FIG. 1. Communications adapter 418 may take many forms, such as, an Ethernet adapter or a wireless modem. Further, display adapter 408 also includes a mechanism to receive user input from a stylus when a touch screen display is employed.

An operating system runs on processor 404 and is used to coordinate and provide control of various components within PDA 400 in FIG. 4. The operating system may be, for example, a commercially available operating system such as Windows CE, which is available from Microsoft Corporation. Other operating systems include: Palm OS from Palm, Inc., EPOCH from Symbian, Inc., RIM OS from Research In Motion, Inc, and Linux OS. Instructions for the operating system and applications or programs are located on storage devices, such as storage 412, and may be loaded into main memory 406 for execution by processor 404.

In these examples, PDA 400 may implement computer instructions for the processes of the present invention. These instructions may be located within main memory 406 or storage 412. Dynamic bookmarks are stored within storage 412. As described before, dynamic bookmarks contain attributes that are used to dynamically bind or search for regular bookmarks that have been augmented or associated with similar attributes.

Those of ordinary skill in the art will appreciate that the hardware in FIG. 4 may vary depending on the implementation. Other internal hardware or peripheral devices, such as flash ROM (or equivalent nonvolatile memory) or optical disk drives and the like, may be used in addition to or in place of the hardware depicted in FIG. 4.

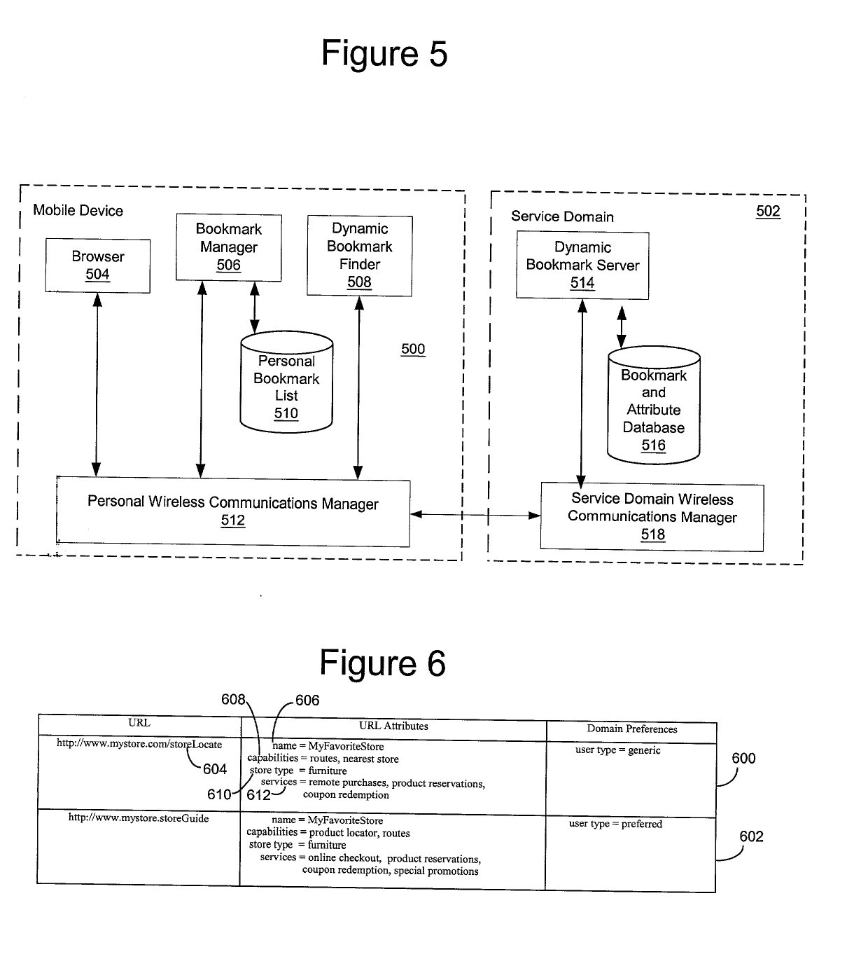

Turning next to FIG. 5, a diagram illustrating components used to implement dynamic bookmarks is depicted in accordance with a preferred embodiment of the present invention. As illustrated, mobile device 500 may be implemented as a PDA, such as PDA 400 in FIG. 4. Service domain 502 may be supported by a server, such as data processing system 200 in FIG. 2.

Mobile device 500 includes a browser 504, bookmark manager 506, dynamic bookmark finder 508, personal bookmark list 510, and personal wireless communications manager 512. Browser 504 is used to present documents, such as Web pages as well as allow for user input to search or browse for information. Bookmark manager 506 provides a process for manipulating, creating, and storing bookmarks in personal bookmark list 510. In addition to containing regular bookmarks, dynamic bookmarks may also be located within bookmark list 510. Alternatively, the dynamic bookmarks may be kept in a separate bookmark list. Dynamic bookmark finder 508 is used to generate requests to obtain bookmarks based on attributes or criteria. These attributes or criteria may be defined by a user. Personal wireless communications manager 512 provides a process for sending requests and receiving responses, such as Web pages and bookmarks.

Service domain 502 includes dynamic bookmark server 514, which maybe located on data processing system 200 in FIG. 2. Additionally, service domain 502 contains a bookmark and attribute database 516, and service domain wireless communications manager 518. Wireless communication may be accomplished by means of Bluetooth, IrDA, cell phone network, or ultra wide band radio. These components also may be located on a data processing system, such as data processing system 200 in FIG. 2. Dynamic bookmark server 514 functions to receive and process requests for bookmarks generated by a client, such as mobile device 500. Dynamic bookmark server 514 will search for bookmarks within bookmark and attribute database 516 in response to receiving a request containing attributes for a dynamic bookmark. The results are placed into a response by dynamic bookmark server 514 and returned to the client. Bookmark and attribute database 516 is an example of a data structure containing bookmarks associated with attributes. Service domain wireless communications manager 518 provides a process for communicating with clients within service domain 502. Service domain 502 may take various forms, such as, for example, a city, a county, a state, geographic region, an office, a building, hospital, a shopping mall, a museum, a recreational facility, a vehicle, a transportation establishment, a health care establishment, an educational establishment, a religious institution, or a charitable institution.

In an alternate embodiment, mobile device 500 is constructed using the latest available technology components such as a Pentium (tm) processor, IBM Micro Drive (tm), and a location determination system such as a global positioning system (GPS) or cell phone location system. Dynamic Bookmark server 514, and dynamic bookmark database 516 shown in FIG. 5 as a part of service domain 502 may then be included within such a mobile device. By using the position obtained from either GPS or cell phone based location one can then determine the effective service domain, and therefore determine the correct bindings for dynamic bookmarks.

For example, a shopper carries a handheld device, such as mobile device 500 along on a shopping trip. The shopper enters a shopping mall in which some stores offer services that are available only when the customer is in the neighborhood of the store. Assume RIE (tm) is one such store. In this example, the store and some portion of the shopping mall around the store form a service domain, such as service domain 502. As the shopper nears RIE and enters service domain 502, the shopper's handheld device, mobile device 500, communicates with dynamic bookmark server 514 which returns a bookmark matching the shopper's criteria. The URL indicated by the returned bookmark contains information on the availability of a product that the shopper inquired about recently, and promotional items specifically available to the shopper. In addition, the URL may contain one or more of the following services: execute purchase, reserve items for purchase, directions to locate items, facilities, amenities, and tour of the facilities. As the shopper enters the store, the shopper is given directions to the location of the product. Information about the availability of the product as well as directions may be received as bookmarks to Web pages containing this information. These bookmarks are received from dynamic bookmark server 514 based on criteria received from mobile device 500 for dynamic bookmarks, which may be stored within personal bookmark list 510.

With this example, as the user enters service domain 502, mobile device 500, carried by the user, discovers that mobile device 500 is now in service domain 502, which provides a dynamic bookmark capability. Once this has been established, dynamic bookmark finder 508 within mobile device 500 asks dynamic bookmark server 514 within service domain 502 if any bookmarks satisfying the criteria provided by dynamic bookmark finder 508 are present. If bookmarks matching the criteria are present, then these matching bookmarks are returned to bookmark manager 506 within mobile device 500, for immediate and/or subsequent use. In this example, personal bookmark list 510 is located in a persistent storage device, such as a flash memory. This type of storage allows for retention of bookmarks for subsequent use. In a preferred embodiment, use of a bookmark implies a URL as a part of the bookmark, and the use of Internet protocols to retrieve the information and/or services associated with that URL by browser 504.

In these examples, a dynamic bookmark is configured by a user during setup of the system or at other times. When mobile device 500 is turned on, dynamic book finder 508 is activated. Personal wireless communications manager 512 monitors for a complimentary service domain communications manager, such as service domain wireless communications manager 518. Once a pairing between these two communication managers occurs, dynamic bookmark finder 508 asks for bookmarks by sending criteria associated with each dynamic bookmark currently defined within mobile device 500. Each set of criteria received by dynamic bookmark server 514 is used to query bookmark and attribute database 516 for bookmarks associated with attributes matching those within the received sets. Any bookmarks found in such a search are returned to dynamic bookmark finder 508 as a response to the request. These bookmarks are in turn sent to bookmark manager 506 for storage and/or display with mobile device 500. Bookmarks are displayed in these examples by presenting the URL associated with the bookmark within browser 504. Additionally, the name associated with the bookmark for the URL also may be presented depending on the particular implementation.

Turning next to FIG. 6, a diagram illustrating sample entries of bookmark and attribute associations is depicted in accordance with a preferred embodiment of the present invention. Entries 600 and 602 are examples of entries that may be found in a server database, such as bookmark and attribute database 516 in FIG. 5. Each entry includes a URL, URL attributes, and domain preferences. A regular bookmark, also referred to just as a bookmark, includes, for example, URL 604 and name 606. Capabilities 608, store type 610, and services 612 within entry 600 are examples of other attributes that may be associated with a bookmark. In addition, a domain may also associate its preferences with a dynamic bookmark. The domain preferences are used to characterize the requester of services, and are used to qualify the requester for different grades of services. Domain preferences help to evaluate the user profile, and typically include characteristics such as credit rating, financial worth, employment status, educational qualifications, marital status, customer status, health status, driving history, etc.

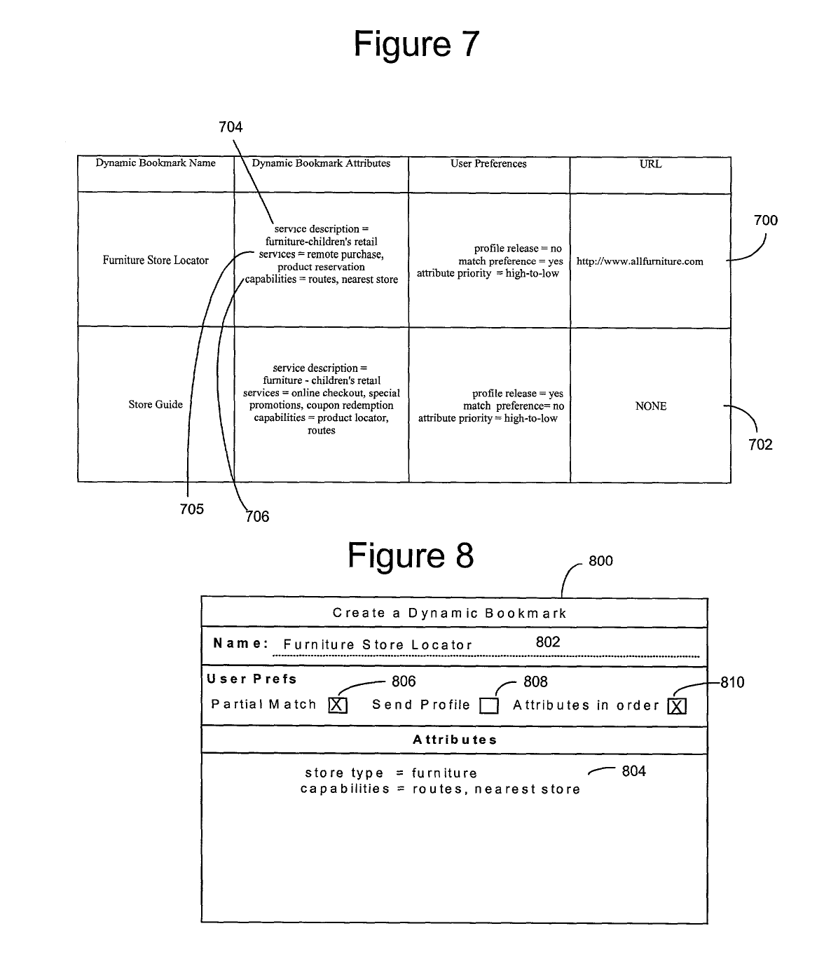

Turning next to FIG. 7, a diagram of dynamic bookmark entries is depicted in accordance with a preferred embodiment of the present invention. Entries 700 and 702 are examples of dynamic bookmark entries, which may be stored on a client, such as mobile device 500 in FIG. 5. In these examples, these entries are located within personal bookmark list 510 within mobile device 500. Each of these entries include a dynamic bookmark name, dynamic bookmark attributes, user preferences and possibly a URL. In these examples, the dynamic bookmark attributes include service description 704 which consists of category descriptions which may be found in one of the following: Yellow Pages Classifications, United Nations Standard Products and Services Codes (UN/SPSC), North American Industry Classification System, or Standard Industrial Classification System, services 705, and capabilities 706 in entry 700. These attributes are sent to a server for comparison with attributes, such as those illustrated in FIG. 6. If matches occur, a bookmark for a corresponding entry is returned to the user at the client. Additionally, user preferences may be set to determine whether a profile of the user is to be sent to the server. If the user chooses to release personal profile information, that information is also sent to the server. Typically, a user profile consists of some combination of the financial status of a user, a user identification, a phone number, a credit card number, and an image. In some cases, a user profile may also include past purchase history, store specified customer type. Furthermore, user preferences may also indicate whether partial matches should return bookmarks. Additionally, through user preferences, an order in which attributes should be matched may be set.

In these examples, service description, services and capabilities are the attributes defined for the dynamic bookmarks in entries 700 and 702. Other attributes may be used in addition to or in place of these attributes. The attributes may include, for example, temporal attributes, contextual attributes, and static attributes. Temporal attributes are, for example, time of day, day, week, season, holiday, birthday, time duration, and anniversary. Contextual attributes include, for example, physical attributes, such as, location, type of establishment, geographical location (ocean, mountains, city, and countryside), political division (state and country), weather conditions, rate of change of location, direction of motion; co-location of people, devices, ATMs, and fax machines. Static attributes may include, for example, service description, services, and capabilities.

Turning next to FIG. 8, a diagram illustrating a graphical user interface (GUI) for creating a dynamic bookmark is depicted in accordance with a preferred embodiment of the present invention. In this example, window 800 is used to receive user input to create a dynamic bookmark. The name of the bookmark may be entered into field 802 as well as attributes within field 804. User preferences, such as allowing a partial match, sending a profile, and searching attributes in order may be selected through check boxes 806, 808, and 810. Through this interface, various dynamic bookmarks may be created by a user, such as those illustrated in FIG. 7.

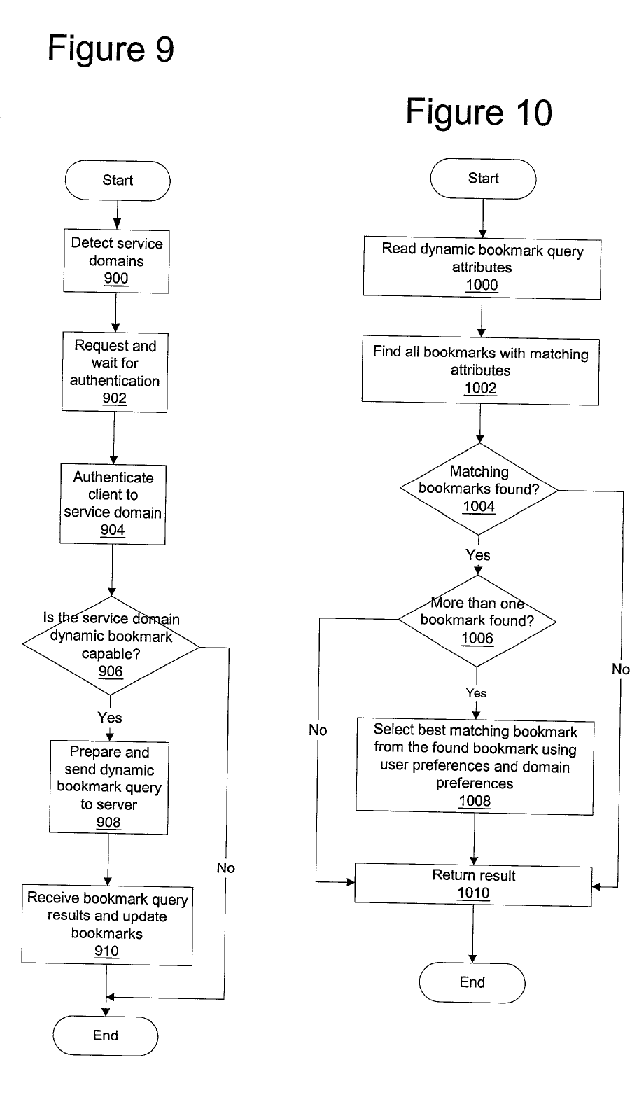

Turning next to FIG. 9, a flowchart of a process for automatically updating dynamic bookmarks in a client is depicted in accordance with a preferred embodiment of the present invention. The process illustrated in FIG. 9 may be implemented as computer instructions within a client, such as mobile device 500. In particular, these processes may be implemented within dynamic bookmark finder 508.

The process begins by detecting service domains (step 900). Thereafter, the client requests the service domain to authenticate itself (step 902). The domain may do so by sending a server certificate it obtained from Internet trust services company, e.g. VeriSign. After the service domain authenticates itself, the client may authenticate itself to the service domain (step 904). This is accomplished by sending a certificate the client has received from a Internet trust services company, e.g. VeriSign. Alternatively, the client may remain anonymous, and send only the information needed for establishing proper communication. Next, a determination is made as to whether the service domain is capable of handling dynamic bookmarks (step 906). This determination may be made by receiving an indicator or message from the server at the service domain indicating that dynamic bookmarks may be handled. This indicator or message may be one broadcast by the server or sent in response to a query or request from the client. If the service domain is capable of handling dynamic bookmarks, then a dynamic bookmark query is prepared and sent to the server (step 908). Bookmark query response is received from the server and the bookmarks are updated (step 910) with the process terminating thereafter. These bookmarks may be stored for later use in a list, such as personal bookmark list 510 in FIG. 5. Turning back to step 906, if the service domain in not capable of handling dynamic bookmarks, the process terminates.

Turning next to FIG. 10, a flowchart of a process for selecting bookmarks for a dynamic bookmark is depicted in accordance with a preferred embodiment of the present invention. The process illustrated in FIG. 10 maybe implemented in a data processing system, such as data processing system 200 in FIG. 2. More specifically, these processes may be implemented as part of dynamic bookmark server 514 in FIG. 5.

The process begins by reading dynamic bookmark query attributes received in a request from a client (step 1000). A search is made for all bookmarks with matching attributes taking into account user preferences, use of partial matches, and attribute matching order (step 1002). In this example, the search is made in a database of bookmarks. A determination is made as to whether matching bookmarks has been found (step 1004). If matching bookmarks are found, a determination is made as to whether more than one bookmark has been found (step 1006). If more than one bookmark has been found, then the best matching bookmark from the bookmarks found is identified based on user preferences and domain preferences (step 1008). The dynamic bookmark matching process selects dynamic bookmarks by matching bookmark attributes received from the client with those in the dynamic bookmark database. If the matching process ends up with more than one dynamic bookmark for a given set of attributes, then the matching process applies the domain preferences to the received user profile to select one dynamic bookmark. Thus, the domain preferences enable a domain to serve different bookmarks to different users. Thereafter, the result is returned to the client (step 1010) with the process terminating thereafter.

With reference again to step 1006, if only one bookmark is found the process proceeds to step 1010 as described above. Turning back to step 1004, if no matching bookmarks are found, the process also proceeds to step 1010.

Thus, the present invention provides a method, apparatus, and computer implemented instructions for managing bookmarks at a client. Through the mechanism of the present invention the amount of user input needed to identify and obtain bookmarks is reduced. This advantage is provided in part through the use of dynamic bookmarks. The mechanism of the present invention automatically sends attributes for dynamic bookmarks to a server at a service domain. These attributes are used to identify bookmarks by searching a set of bookmarks. This set of bookmarks is associated with attributes. The attributes associated with the bookmarks are compared with those sent from the client for the dynamic bookmarks. Matches are identified and a result is returned to the client. All matching bookmarks may be returned or some portion of the matching bookmarks may be returned. The number of bookmarks returned when multiple bookmarks are identified may be set by the service or a user through user preferences. These bookmarks are then presented and/or stored at the client. All of these actions require no active user input. The request for the bookmarks is generated when the client connects to or enters a particular service domain in these examples.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The depicted examples illustrate the use of the present invention with mobile devices entering a service domain. The processes of the present invention also may be used with non-mobile clients, such as a workstation or personal computer. In this instance, a request may be initiated upon establishment of a communications link with a particular server. For example, if a user logs on to a particular Web site or type of Web site, the request for bookmarks may be made in response to this connection. Although the depicted illustrations show the mechanism of the present invention embodied on a single server, this mechanism may be distributed through multiple data processing systems. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing bookmarks, the method comprising:
responsive to detecting a service domain with a dynamic bookmark service, sending a request containing criteria identifying a dynamic bookmark to the service domain;
receiving a response to the request; and
processing bookmarks received in the response, wherein bookmarks returned in the request are bookmarks matching the dynamic bookmark.

2. The method of claim 1, wherein the processing step comprising:
storing any bookmarks for use by a browser program.

3. The method of claim 1, wherein the processing step comprising:
presenting the desired bookmark in a browser program.

4. The method of claim 1, wherein the service domain covers one of a city, a county, a state, geographic region, an office, a building, hospital, a shopping mall, a museum, a recreational facility, a vehicle, a transportation establishment, a health care establishment, an educational establishment, a religious institution, or a charitable institution.

5. The method of claim 1, wherein the sending step is performed using a wireless communications link.

6. The method of claim 5 wherein the wireless communication link is one of Bluetooth, IrDA, cell phone network, or ultra wide band radio.

7. The method of claim 1 wherein the data processing system is one of Palm OS, Windows CE, Linux, EPOCH, and RIM OS.

8. The method of claim 1, wherein the desired bookmark includes a universal resource locator.

9. The method of claim 1, wherein any bookmarks identify services available within the service domain.

10. The method of claim 9, wherein the services available are at least one of list items offered for sale, execute a purchase, reserve items for purchase, directions to locate items, list facilities, list amenities, provide tour of the facilities.

11. The method of claim 1, wherein the response further includes, in association with any bookmarks, at least one of a name of service provider, an identifications of services offered by the service provider, and a location of the service provider.

12. The method of claim 1, wherein the criteria includes at least one of a temporal attribute, a contextual attribute, and a static attribute, a user profile, and user preferences.

13. The method of claim 12, wherein the temporal attribute includes at least one of a time of day, day of a week, a season, a holiday, a birthday, a time duration, and an anniversary.

14. The method of claim 12, wherein the contextual attribute includes at least one of a location, a type of establishment, a geographic location, a political division, a weather condition, a rate of change of location, a direction of motion, a co-location of a person.

15. The method of claim 12, wherein the static attribute includes at least one of service description, list of services, list of capabilities.

16. The method of claim 15, wherein the service description includes categories from at least one of Yellow Pages Classification, United Nations Standard Products and Services Codes (UN/SPSC), North American Industry Classification System, and Standard Industrial Classification System.

17. The method of claim 15, wherein the list of services include at least one of remote purchases, product reservations, online checkout, special promotions, and coupon redemption.

18. The method of claim 15, wherein the list of capabilities include at least one of routes, maps, directions to locate items, facilities, amenities, tour of the facilities.

19. The method of claim 12, wherein the user profile includes at least one of a financial status of a user, a user identification, a phone number, a credit card number, and an image.

20. The method of claim 12, wherein the user preferences include at least one of profile release indicator, match preference indicator, attribute priority indicator.

21. A method in a data processing system for managing bookmarks, the method comprising:
receiving a request from a client, wherein the client includes a criteria identifying a dynamic bookmark for a service domain;
querying a data structure using the criteria for the dynamic bookmark to generate a result; and
returning a response to the client, wherein the response includes the result.

22. The method of claim 21, wherein the service domain covers one of a city, a county, a state, geographic region, an office, a building, a hospital, a library, a shopping mall, a business establishment, a museum, a recreational facility, a vehicle, a government institution, a transportation establishment, a health care establishment, an educational establishment, a religious institution, or a charitable institution.

23. The method of claim 21, wherein the desired bookmark includes a universal resource locator.

24. The method of claim 21, wherein the data structure is a database.

25. The method of claim 21, wherein the criteria includes at least one of a temporal attribute, a contextual attribute, and a static attribute, a user profile, and user preferences.

26. The method of claim 25, wherein the temporal attribute includes at least one of a time of day, day of a week, a season, a holiday, a birthday, a time duration, and an anniversary.

27. The method of claim 25, wherein the contextual attribute includes at least one of a location, a type of establishment, a geographic location, a political division, a weather condition, a rate of change of location, a direction of motion, a co-location of a person.

28. The method of claim 25, wherein the static attribute includes at least one of type service description, a list of services, and a list of capabilities.

29. The method of claim 28, wherein the service description includes categories from at least one of Yellow Pages Classification, United Nations Standard Products and Services Codes (UN/SPSC), North American Industry Classification System, Standard Industrial Classification System.

30. The method of claim 28, wherein the list of services include at least one of remote purchases, product reservations, online checkout, special promotions, coupon redemption.

31. The method of claim 28, wherein the list of capabilities include at least one of routes, maps, directions to locate items, facilities, amenities, and tour of the facilities.

32. The method of claim 28, wherein the user profile includes at least one of a financial status of a user, a user identification, a phone number, a credit card number, and an image.

33. The method of claim 25, wherein the user preferences include at least one of profile release indicator, match preference indicator, or attribute priority indicator.

34. The method of claim 21, wherein the data structure associates at least one of a temporal attribute, a contextual attribute, a static attribute, and domain preferences.

35. The method of claim 34, wherein the domain preferences include at least one of a credit rating, financial worth, employment status, educational qualifications, marital status, customer status, health status, and driving history.

36. A network data processing system comprising:
a network;
a plurality of clients connected to the network, wherein a client generates a request for bookmarks using a set of criteria;
a server connected to the network, wherein the server receives the request, queries a data structure using the criteria for a bookmark corresponding to the set of criteria to generate a result, and returns a response to the client, wherein the response includes the result.

37. The network data processing system of claim 36, wherein the network is at least one of a wireless network, a local area network, an Internet, and an intranet.

38. The wireless network data processing system of claim 36, wherein the plurality of clients include at least one of a personal digital assistant, a cellular phone, an embedded device, and a watch.

39. A server system comprising:
a communications manager, wherein the communications manager establishes and manages communications links with a client;
a bookmark and attribute database, wherein the bookmark and attribute database includes a set of bookmarks associated with a plurality of attributes;
a dynamic bookmark server, wherein the dynamic bookmark server receives a request from the client from the communications manager in which the request includes a set of criteria, queries the bookmark and attribute database using the set of criteria for bookmarks within the set of bookmarks associated with attributes within the plurality of attributes matching the set of criteria, receives a result from the bookmark and attribute database, and sends a response to the communications manager for return to the client, wherein the response includes the result.

41. A data processing system comprising:
a communications manager, wherein the communications manager establishes and manages communications with a server system;
a dynamic bookmark finder, wherein the dynamic bookmark finder sends a request containing a set of criteria for desired bookmarks and receives a response from the server system; and
a bookmark manager, wherein the bookmark manger stores the desired bookmarks received by the dynamic bookmark finder in a data structure of bookmarks.

42. A data processing system for managing bookmarks, the method comprising:
managing means, responsive to detecting a service domain with a dynamic bookmark service, sending a request containing criteria identifying a dynamic bookmark to the service domain;
receiving means for receiving a response to the request; and
processing means for processing any bookmarks received in the response, wherein any bookmarks returned in the request are bookmarks matching the dynamic bookmark.

43. The data processing system of claim 42, wherein the processing means comprises:
storing means for storing any bookmarks for use by a browser program.

44. The data processing system of claim 42, wherein the processing means comprises:
presenting means for presenting the desired bookmark in a browser program.

45. The data processing system of claim 42, wherein the service domain covers one of a city, a county, a state, geographic region, an office, a building, hospital, a shopping mall, a museum, a park, or a vehicle.

46. The data processing system of claim 42, wherein the sending means uses a wireless communications link.

47. The data processing system of claim 42, wherein the desired bookmark includes a universal resource locator.

48. The data processing system of claim 42, wherein any bookmarks identify services available within the service domain

49. The data processing system of claim 48, wherein the services available is an identification of an item offered for sale.

50. The data processing system of claim 42, wherein the response further includes, in association with any bookmarks, at least one of a name of service provider, an identifications of services offered by the service provider, and a location of the service provider.

51. The data processing system of claim 42, wherein the criteria includes at least one of a temporal attribute, a contextual attribute, and a static attribute.

52. The data processing system of claim 51, wherein the temporal attribute includes at least one of a time of day, day of a week, a season, a holiday, a birthday, and an anniversary.

53. The data processing system of claim 51, wherein the contextual attribute includes at least one of a location, a type of establishment, a geographic location, a political division, a weather condition, a rate of change of location, a direction of motion, a co-location of a person, a financial status of a user, a user identification, a phone number, a credit card number, and an image.

54. The data processing system of claim 51, wherein the static attribute includes at least one of a personal preference of a user and a preference of a service provider.

55. A data processing system for managing bookmarks, the method comprising:
receiving means for receiving a request from a client, wherein the client includes a criteria identifying a dynamic bookmark for a service domain;
querying means for querying a data structure using the criteria for the desired bookmark to generate a result; and
returning means for returning a response to the client, wherein the response includes the result.

56. The data processing system of claim 55, wherein the service domain covers one of a city, a county, a state, geographic region, an office, a building, hospital, a shopping mall, a museum, a park, or a vehicle.

57. The data processing system of claim 55, wherein the desired bookmark includes a universal resource locator.

58. The data processing system of claim 55, wherein the data structure is a database.

59. The data processing system of claim 55, wherein the criteria includes at least one of a temporal attribute, a contextual attribute, and a static attribute.

60. The data processing system of claim 59, wherein the temporal attribute includes at least one of a time of day, day of a week, a season, a holiday, a birthday, and an anniversary.

61. The data processing system of claim 59, wherein the contextual attribute includes at least one of a location, a type of establishment, a geographic location, a political division, a weather condition, a rate of change of location, a direction of motion, a co-location of a person, a financial status of a user, a user identification, a phone number, a credit card number, and an image.

62. A data processing system comprising:
a bus system;
a communications unit connected to the bus, wherein data is sent and received using the communications unit;
a memory connected to the bus system, wherein a set of instructions are located in the memory; and
a processor unit connected to the bus system, wherein the processor unit executes the set of instructions to respond to detecting a service domain with a dynamic bookmark service, send a request containing criteria identifying a dynamic bookmark to the service domain, receive a response to the request, and process any bookmarks received in the response, wherein any bookmarks returned in the request are bookmarks matching the dynamic bookmark.

63. A data processing system comprising:
a bus system;
a communications unit connected to the bus, wherein data is sent and received using the communications unit;
a memory connected to the bus system, wherein a set of instructions are located in the memory; and
a processor unit connected to the bus system, wherein the processor unit executes the set of instructions to receive a request from a client in which the request includes a criteria identifying a dynamic bookmark for a service domain, query a data structure using the criteria for the desired bookmark to generate a result, and return a response to the client, in which the response includes the result

64. A computer program product in a computer readable medium for managing bookmarks, the computer program product comprising:
first instructions, responsive to detecting a service domain with a dynamic bookmark service, sending a request containing criteria identifying a dynamic bookmark to the service domain;
second instructions for receiving a response to the request; and
third instructions for processing any bookmarks received in the response, wherein any bookmarks returned in the request are bookmarks matching the dynamic bookmark.

65. The computer program product of claim 64, wherein the third instructions comprising:
sub-instructions for storing any bookmarks for use by a browser program.

66. The computer program product of claim 64, wherein the third instructions comprising:
sub-instructions for presenting the desired bookmark in a browser program.

67. The computer program product of claim 64, wherein the service domain covers one of a city, a county, a state, geographic region, an office, a building, hospital, a shopping mall, a museum, a park, or a vehicle.

68. The computer program product of claim 64, wherein the third instruction uses a wireless communications link.

69. The computer program product of claim 64, wherein the desired bookmark includes a universal resource locator.

70. The computer program product of claim 64, wherein any bookmarks identify services available within the service domain

71. The computer program product of claim 70, wherein the services available is an identification of an item offered for sale.

72. The computer program product of claim 64, wherein the response further includes, in association with any bookmarks, at least one of a name of service provider, an identifications of services offered by the service provider, and a location of the service provider.

73. The computer program product of claim 64, wherein the criteria includes at least one of a temporal attribute, a contextual attribute, and a static attribute.

74. The computer program product of claim 73, wherein the temporal attribute includes at least one of a time of day, day of a week, a season, a holiday, a birthday, and an anniversary.

75. The computer program product of claim 73, wherein the contextual attribute includes at least one of a location, a type of establishment, a geographic location, a political division, a weather condition, a rate of change of location, a direction of motion, a co-location of a person, a financial status of a user, a user identification, a phone number, a credit card number, and an image.

76. The computer program product of claim 73, wherein the static attribute includes at least one of a personal preference of a user and a preference of a service provider.

77. A computer program product in a computer readable medium for managing bookmarks, the computer program product comprising:
first instructions for receiving a request from a client, wherein the client includes a criteria identifying a dynamic bookmark for a service domain;
second instructions for querying a data structure using the criteria for the desired bookmark to generate a result; and
third instructions for returning a response to the client, wherein the response includes the result.

78. The computer program product of claim 77, wherein the service domain covers one of a city, a county, a state, geographic region, an office, a building, hospital, a shopping mall, a museum, a park, or a vehicle.

79. The computer program product of claim 77, wherein the desired bookmark includes a universal resource locator.

80. The computer program product of claim 77, wherein the data structure is a database.

81. The computer program product of claim 77, wherein the criteria includes at least one of a temporal attribute, a contextual attribute, and a static attribute.

82. The computer program product of claim 81, wherein the temporal attribute includes at least one of a time of day, day of a week, a season, a holiday, a birthday, and an anniversary.

83. The computer program product of claim 81, wherein the contextual attribute includes at least one of a location, a type of establishment, a geographic location, a political division, a weather condition, a rate of change of location, a direction of motion, a co-location of a person, a financial status of a user, a user identification, a phone number, a credit card number, and an image.
